(19) United States
(12) Patent Application Publication
(10) Pub. No.: US 2017/0259543 A1
(43) Pub. Date: Sep. 14, 2017

(54) ADHESIVE WATERPROOF TAPE SYSTEM FOR ROOFING AND FLASHING

(71) Applicant: Roofers' Advantage Products, LLC, East Wakefield, NH (US)

(72) Inventor: Jonny E Folkersen, East Wakefield, NH (US)

(21) Appl. No.: 15/608,484

(22) Filed: May 30, 2017

Related U.S. Application Data
(63) Continuation of application No. 12/537,242, filed on Aug. 6, 2009, now abandoned.

(51) Int. Cl. B32B 27/36; B32B 7/06; E04D 13/147; B32B 17/02

(52) U.S. Cl. CPC B32B 27/36; B32B 17/02; B32B 7/06; E04D 13/147; E06B 2001/628

(57) ABSTRACT

A house sealing method is herein provided. The method involves using a tacky on both sides detail membrane having a reinforced inner core to seal various areas of a building envelope.

### RELATED APPLICATIONS

This application is a continuation of U.S. application Ser. No. 12/537,242, filed Aug. 6, 2009. This application is herein incorporated by reference in its entirety for all purposes.

### FIELD OF THE INVENTION

The invention pertains generally to the field of asphalt-based roofing systems. More particularly, the invention pertains to materials and methods for waterproofing a building structure, using an asphalt-based, fiberglass-reinforced building envelope detail membrane.

### BACKGROUND OF THE INVENTION

The home building and roofing industries have gone through a number of technological changes, resulting in code changes to meet the demands of high-wind and moisture mitigation requirements. These technological changes and advances include, but are not limited to, the use of self-adhered underlayments, dimensional shingles, ridge vents, house wraps, synthetic underlayments and the use of better engineered metal components within the residential and commercial building envelope marketplace.

For example, a number of sticky on one side roofing underlayments have become code mandated and are used throughout the country, when protecting the building envelope from wind-driven rain or from other weather phenomena, such as ice damming. Generally, the reinforcement is the surface material itself and may consist of various types of films, mats, foils and mineral granules. Such a product is manufactured by W.R. Grace & Co. and is known by the trade name of Grace Ice & Water Shield®. Other roofing product systems and techniques are disclosed, for example, by U.S. Pat. No. 4,757,652.

These prior art underlayments are self-adhesive on one side, with the other side consisting of a granule or plastic surface, thereby preventing the adhesion of the underside of the synthetic underlayment to the top side of the self-adhesive underlayment. Furthermore, once moisture gets through the primary roof covering, it may travel under the synthetic underlayment, causing moisture infiltration into the building envelope.

Prior art ridge vent systems and techniques are disclosed, for example, by U.S. Pat. No. 3,949,657 and starter strip shingle types and systems are disclosed, for example, by U.S. Pat. No. 6,874,289. U.S. Pat. No. 5,843,522 discloses sealing the overlap of membranes and U.S. Pat. No.6, 701,685 discloses bonding a lowermost course of shingles to a roof deck.

One known product manufactured by Protecto Wrap Company® of Denver, Colo. is called Jiffey Seal 140/60. This product is an internally strengthened and reinforced sheet waterproofing membrane, which has been used at such locations as: foundation walls, decks, balconies, bathrooms, terraces, and parking structures. When used for roofing, however, it was discovered that the adhesive mass is prone to delaminating from the polyester core, particularly when the temperature increases and a roof mechanic's clothing comes into contact with the adhesive mass.

Thus, one problem commonly encountered in the field is how to integrate the new technologies and code requirements into the greater system itself, thereby providing both short-term (e.g., while under construction) and long-term (e.g., after system completion) benefits, which these products are advancing. In attempts to provide for bonding of roofing cover materials to underlying roofing materials and provide for bonding of similar roofing materials, exhaustive efforts have made to find a uniform, easy to apply, cost effective product, which meets industry needs and overcomes the limitations of commonly used materials, such as, for example, plastic roof cement, EPDM based caulk and butyl rubber. However, the prior art to date fails to address these problems adequately.

### SUMMARY OF THE INVENTION

The present invention provides materials and methods for waterproofing a building structure or portion thereof, including the steps of providing a roofing structure to be protected from water and applying a waterproof adhesive tape to the roofing structure. In accordance with one aspect of the present invention, storm resistant building envelope details are provided, when roofing or working on the building envelope, by bonding a cover material to the underlying material. In accordance with another aspect of the present invention, bonding of similar roofing materials is provided, when a watertight shell is desirable (for example, while under construction), thereby providing redundancy, should the cover material fail.

In the preferred embodiment, the waterproof adhesive tape comprises a detail membrane including a reinforced hiller core having first and second sides, with a tacky, bitumen-based adhesive on the first and second sides of the reinforced inner core, and with rubber polymers and/or styrene-rubber block copolymers and/or other elastic materials added to the bitumen-based adhesive. The detail membrane either bonds an underside of an exposed cover roofing material to an underlying roofing material on a building envelope, or bonds two like roofing materials together on a building envelope, or replaces caulking, plastic roof cement, mastic or any traditional material used on a sloped-roof roofing structure or the walls of a building exterior. The roofing structure can be, for example, roofing, flashing, protrusions through the roof, or walls that abut the roofing structure.

By providing a sticky on both sides, core-reinforced detail membrane, the field termination and bonding of the cover material to the underlying new technology is enhanced. Furthermore, the new roofing material technologies can be bonded to themselves, using the present invention, thereby providing for short term (e.g., while under construction) wind and moisture mitigation benefits and the long term benefits of increasing the point at which cover materials are affected by wind and/or other external factors. The present invention thus provides a novel solution to the long-standing need for storm-resistant details among manufacturers, insurance companies, architects, engineers, distributors, code offices and contractors.

These and other features and advantages will become readily apparent from the following detailed description, which should be read in conjunction with the accompanying drawing figures.

### BRIEF DESCRIPTION OF THE DRAWINGS

Reference is now made to the accompanying drawings. The drawings are not necessarily to scale, with the emphasis instead placed upon the principles of the present invention. Additionally, each of the embodiments depicted are but one of a number of possible arrangements, utilizing the fundamental concepts of the present invention. The drawings are briefly described as follows.

FIG. 1 is a partial view and cross section of waterproof detail membrane of the invention installed at head—side laps and at eave—rake field termination points, when using synthetic underlayment, in accordance with an embodiment of the invention;

FIG. 2 is a partial view and cross section of waterproof detail membrane of the invention installed at laps and field terminations, when using house wraps, in accordance with an embodiment of the invention;

FIG. 3 is a partial view of waterproof detail membrane of the invention bonding rake shingles to the rake drip edge and the underlayment, in accordance with an embodiment of the invention;

FIG. 4 is a partial view of a side wall with waterproof detail membrane of the invention adhered to the step flashing thereby providing for house wrap adhesion at the interface of the flashing and house wrap, in accordance with an embodiment of the invention;

FIG. 5 is a partial view of waterproof detail membrane of the invention bonding head wall flashing to the bottom edge of the house wrap and bonding of the roof covering to the head wall flashing, in accordance with an embodiment of the invention;

FIG. 6 is a partial view of two chimneys, showing the installation of waterproof detail membrane of the invention onto the substrate and up the vertical incline underneath the flashing components, and furthermore at the laps in the lead of metal step counter flashing, in accordance with an embodiment of the invention;

FIG. 7 is a partial view of roof covering terminating into a metal valley and the waterproof detail membrane of the invention bonding the valley flashing to the roof covering, in accordance with an embodiment of the invention;

FIG. 8 is a cross section of a deck ledger, which has the waterproof detail membrane of the invention installed behind the deck ledger, and a second course bent over to cover the top of ledger, prior to installing metal cap flashing, in accordance with an embodiment of the invention;

FIG. 9 is a partial view of a skylight, showing the waterproof detail membrane of the invention installed under the shingle and up the vertical incline of the skylight, prior to the installation of the cover material, in accordance with an embodiment of the invention;

FIG. 10 is a partial view of a ridge vent, showing the waterproof detail membrane of the invention applied to a ridge vent, prior to installation of the ridge cap, in accordance with an embodiment of the invention;

FIG. 11 is a partial view of waterproof detail membrane of the invention installed onto the drip edge and extended under the synthetic underlayment of self-adhered underlayment, providing for starter course adhesion, in accordance with an embodiment of the invention;

FIG. 12 is a partial view of the waterproof detail membrane of the invention installed onto the drip edge and over the self adhered underlayment, eliminating the gap at the interface of the underlayment and drip edge, while providing for starter course adhesion, in accordance with an embodiment of the invention;

FIG. 13 is a partial view of waterproof detail membrane of the invention installed around a window, in accordance with an embodiment of the invention;

FIG. 14 is a partial view of waterproof detail membrane of the invention installed around a door, in accordance with an embodiment of the invention; and

FIG. 15 shows a view of a building depicting several points at which to apply the waterproof detail membrane of the invention.

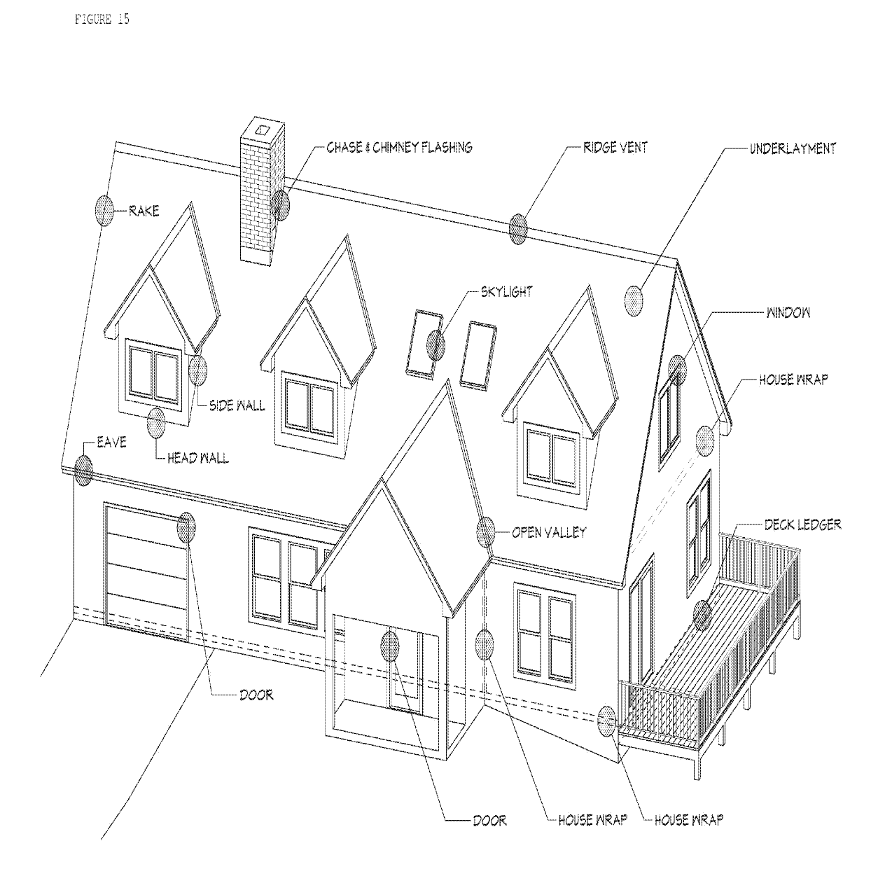

### DETAILED DESCRIPTION

The present invention provides an improved detail membrane for bonding together materials of a building envelope, which includes a reinforced inner core having first and second sides, a tacky, bitumen-based adhesive on the first and second sides of the reinforced inner core, rubber polymers and/or styrene-rubber block copolymers and/or other elastic materials added to the bitumen-based adhesive. The detail membrane either bonds an underside of an exposed cover roofing material to an underlying roofing material on a building envelope, or bonds two like roofing materials together on a building envelope, or replaces caulking, plastic roof cement, mastic or any traditional material used on a sloped roof or the walls of a building exterior. The roofing structure can be roofing, flashing, protrusions through the roof, or walls that abut the roofing structure.

In accordance with a preferred embodiment of the invention, a 40 mil thick detail membrane comprises a fiberglass mat embedded with polymer rubbers, such as styrene-butadiene rubber, and styrene-rubber block copolymers, such as styrene-butadiene-styrene and styrene-isoprene-styrene block copolymers, and including emulsifiers or other such products, which are added to bitumen to improve thermal and mechanical properties of the adhesive mass.

The preferred use of fiberglass versus a polyester inner core permits for the inner core to be bound by the adhesive mass. The fiberglass also prevents elongation tendencies, while being installed, and further prevents the leaking of the adhesive mass, when exposed to higher temperatures, such as when installed under metal roofing. Fiberglass mats have been used in the roofing industry for decades and have proven to be a cost effective, durable solution as a reinforcement and base for application of various materials used in the roofing industry. These mats are readily available from Saint-Gobain Group Company® and other providers of fiberglass mats to manufacturers of roofing products.

It should be noted that the use of the above-described materials is for illustration purposes and that other polymers and elastomers are suitable, such as described herein. Likewise, the use of fiberglass as a core reinforcement material is for illustration purposes only, and it is understood that other materials can be used to reinforce the detail membrane. Furthermore, the ratios of polymers used in preparing a mixture and the thickness of the fiberglass mat may vary, depending of the physical and chemical properties needed in a waterproofing material and/or for a particular application.

A release liner preferably is installed on both adhesive sides as a continuous application. Preferably, the release liner is a polyethylene, polypropylene or polyester composition. The release liners preferably are treated on the side facing the adhesive mass, using a silicone adhesive preventing sticking of the adhesive mass to the release liner. The use of a single release liner is possible, if the release liner has a silicone adhesive applied to both sides to permit for unrolling of the product.

The installation of the detail membrane requires only a minimum of skill and labor, and the product is capable of efficient and inexpensive manufacture. Related materials receiving the detail membrane of the present invention should be clean and dry having been installed according to manufacturer instructions. Surfaces should be above 45 degrees Fahrenheit and may require additional temperature increase and time to fully adhere as designed. Remove the top release liner only once the cover material is ready to be installed, so as to avoid contamination of the adhesive mass. Press the cover material into the adhesive mass, using a roller or by applying adequate pressure, so as to provide for an aggressive bond. An adequate bond requirement has been met, when you pull up on the cover material and a gum-like consistency is evident. The detail membrane is easiest to install when working with an assistant. Begin the application by unrolling approximately 12″ from the roll and remove any backer film as required. With your assistant, unroll approximately 3′ to 4′ at a time, with one person keeping the roll elevated and the other installing the detail membrane. Press or roll the detail membrane into place, continuing this process until area is completed. On smaller applications, one person may be able to complete the application. Generally, include 4″ side laps and uphill courses should always lap downhill courses to ensure watershed.

A typical problem, and the need for the detail membrane of the present invention, arises when the General Contraction (GC) wants an immediate water-tight building envelope, prior to the trim package being installed. Without the exterior trim package, the roofer has nothing to butt the drip edge to at the eave location, and will generally install the self-adhered underlayment onto the substrate, providing for a temporary water-tight building envelope. The GC is now able to get other mechanical systems underway, such as plumbers and electricians, without completing the exterior trim package, until a later date. Several months may go by and the roofer returns to install the cover roofing materials and is not able to peel the self-adhered underlayment from the substrate, resulting in the drip edge being installed on top of the self-adhered underlayment. The problem with this application is that a gap is left at the interface of the underside of the drip edge and the top side of the poly or granule top surface of the self-adhered underlayment, resulting in water infiltration during inclement weather, such as ice damming, causing water to leak through the soffit and potentially into the building envelope.

Installing the detail membrane of the present invention from the drip edge onto the underlayment eliminates the gap at the interface of the drip edge and the underlayment, and provides for starter course adhesion, preventing moisture infiltration and providing for a storm-resistant detail.

Reference is now made to the accompanying drawings, by way of examples, showing various embodiments in which the detail membrane of the present invention is installed, and used in combination with: ridge vents, chimneys, skylights, deck ledgers, eaves (under), eaves (over), head wall flashing, side wall flashing, valleys, windows, doors, house wraps, rake edge and synthetic underlayments.

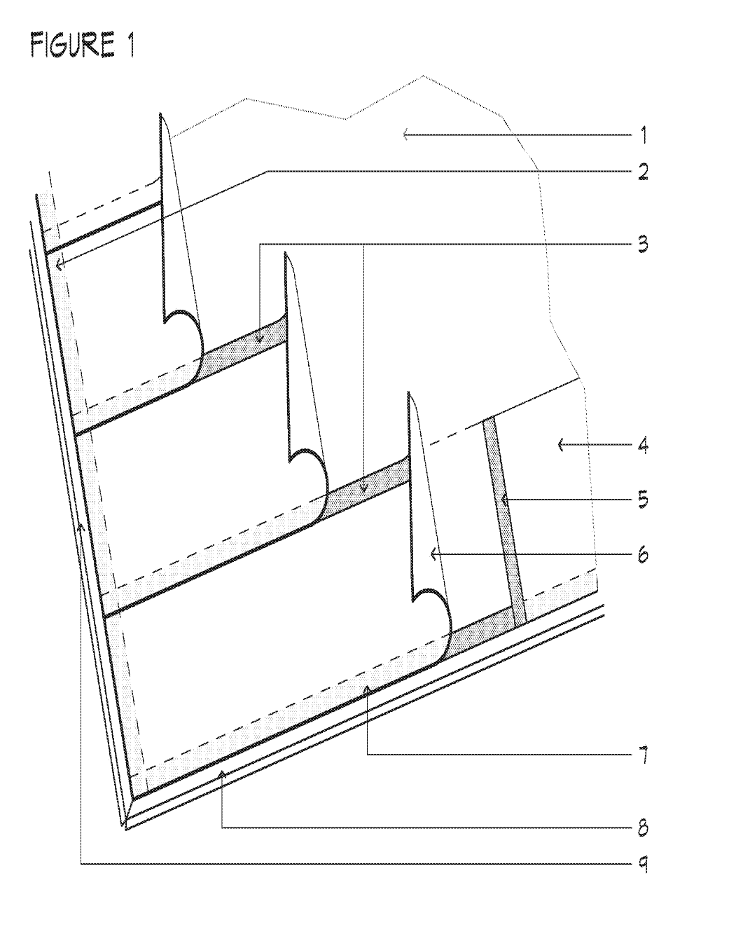

Referring now to FIG. 1, the detail membrane 2 of the present invention is installed at eaves, rakes, side and head laps 3,5 and bonded to a synthetic underlayment 4,6 laid over roof sheathing 1. Generally, the detail membrane 2 is installed on top of the eave and rake drip edges 8, 9. At the eave location, install on top of the drip edge, leaving the top release liner in place, until the underlayment has been installed, then remove the top release liner to provide for positive adhesion of the underlayment. Once the top film has been removed, press the underlayment downward towards the eave, to provide for an aggressive bond without fish-mouthing. At the rake location, install the underlayment first and place the drip edge 011 top of the underlayment. Once the drip edge has been fastened, install the detail membrane on top of the rake drip edge to provide for positive roof adhesion. The detail membrane of the present invention is compatible with over a dozen synthetic Underlayments available today. When installing the detail membrane of the present invention underneath the synthetic underlayment, the additional benefit of nail seal is achieved, as called out when meeting the requirements of ASTM D-1970.

The use of synthetic underlayments is a one billion dollar industry and growing, particularly as the price of oil continues to fluctuate, driving the market away from the use of felt and tar paper underlayments. Examples of such products are: ROOFTOPGUARD II as manufactured by ROSENLEW RKW Finland Ltd. Another non-limiting example of a synthetic underlayment is REXTM SynFelt as manufactured by Alpha Pro Tech Engineered Products, Inc. Yet another non-limiting example of such a product is TITANIUM™ UDL-30 as manufactured by InterWrap Inc.

These and similar products can be left exposed up to six months, which may become necessary after a natural disaster, such as a hurricane, when it becomes difficult to procure roofing materials and labor. The introduction of the detail membrane of the present invention into a market such as Florida would enhance the performance of synthetic underlayments currently being installed. The use of synthetic underlayment will likely further increase and may become aided, because the use of the detail membrane of the present invention in conjunction with synthetic underlayments is substantially less expensive than using self-adhered underlayment on 100% of the roof deck, as is becoming common in some areas.

Manufacturers of synthetic underlayment are aware of the problems with prolonged exposure and generally call out the same detail, as exemplified by the application instructions for ROOFTOPGUARD II ™ as follows: “where seams or joints require sealant or adhesive, use only a high quality, low solvent asbestos free plastic roofing cement meeting ASTM D-4586 Type 1 (Asbestos Free), Spec SS-153 Type 1 (Asbestos Free). In areas subject to wind-driven rain where the underlayment will be left exposed to the weather for an extended period of time, seal all seams with a butyl rubber, urethane, or EPDM based caulk or tape sealant”.

The ROOFTOP GUARD II™ product line is in the process of calling out the detail membrane of the present invention by name, as the detail membrane of the present invention outperforms these other mastics and is a cost effective solution to butyl tapes, which can be difficult to work with and are prone to elongation tendencies.

The detail membrane of the present invention is compatible with the vast majority of synthetic Underlayments on the market today. The detail membrane can be installed at head and side laps, as well as rake and eave edges, providing for possible starter course adhesion, where applicable. In addition, the detail membrane of the present invention may be installed onto the top side of the synthetic underlayment and extend onto the substrate, thereby providing for additional bonding to the substrate, as is typical with fully-adhered products. This application can decrease the number of fasteners required, while maintaining the requisite holding power to the substrate.

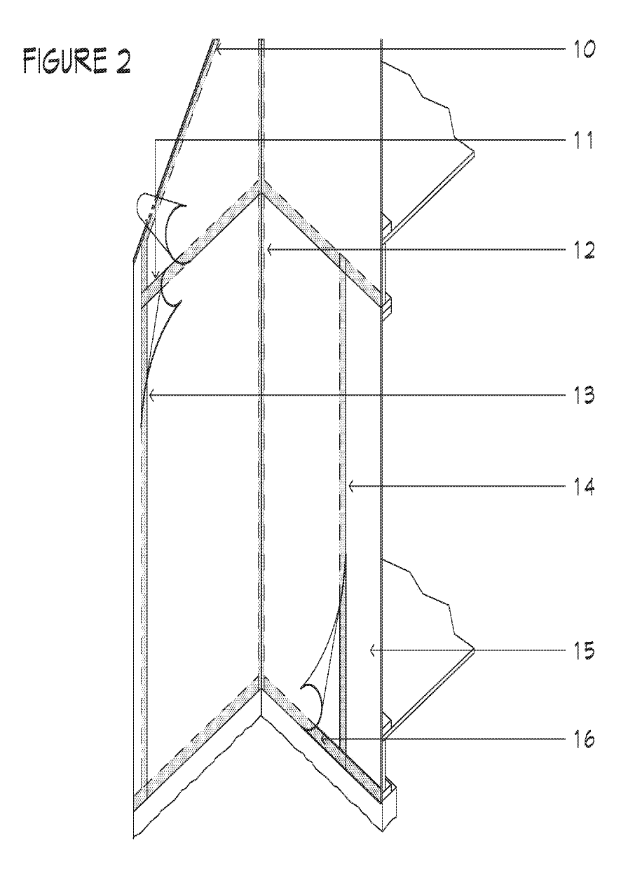

Referring now to FIG. 2, the use of house wraps increases the air and water resistance of the building envelope by increasing protection from weather related elements. Two examples of such products are DuPont™ Tyvek® and REX™ Wrap or REX™ Wrap Plus, as manufactured by Alpha Pro Tech Engineered Products, Inc. The manufacturers of these two products consider it a best practice and a final step, when a seamless protective envelope is created using one of the following tapes: DuPont™ Tyvek® Tape and REX™ Bluebond Seaming Tape. These seaming tapes are generally based on an acrylic adhesive method, but are intended as a surface covering only. The detail membrane 10 can be applied to wall sheathing 15, at the bottom edge of sheathing 16, head laps 11, side laps 13, 14, corners 12, and at gable end terminations when installing house wraps. Install the detail membrane high enough on the flashing, so as to avoid visible signs of its installation, once the siding has been completed. Do not remove the top release liner, until the desired house wrap has been installed. At the appropriate time, remove the top side release liner, providing for a strong positive bond between the house wrap and the detail membrane.

The use of the detail membrane of the present invention provides for a bond at the head and side laps of the house wraps, without being exposed to the exterior of the building envelope at any time, as the product is sandwiched between the house wrap and field termination areas, such as gable ends and along the foundation area itself. As an alternative to house wraps tapes, which will not bond the bottom edge of the sheathing or the top edge at a gable end, the detail membrane of the present invention will provide for direct adhesion at the interface of the back side of the house wrap and the exposed side of the substrate, thereby providing for nail seal at these locations.

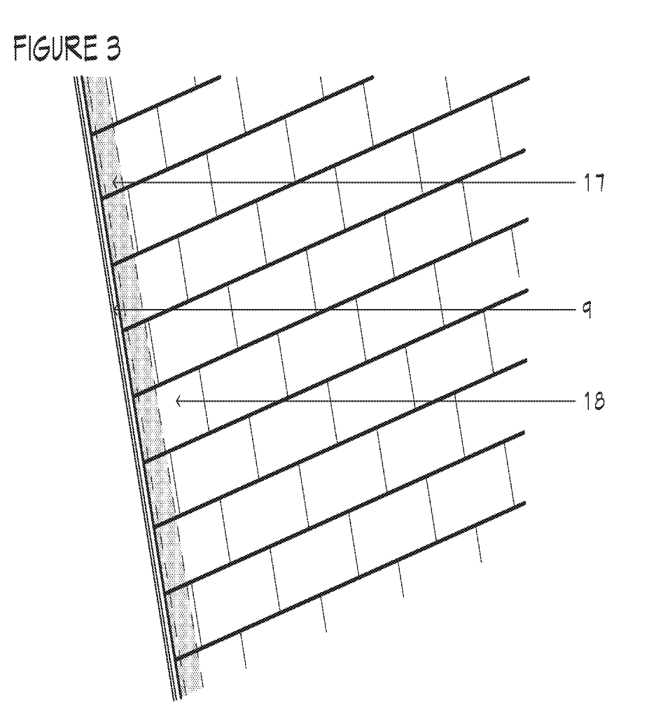

Referring now to FIG. 3, the rake edge of the roof plane can be exposed to direct wind shear and prone to failure under extreme conditions. Install the detail membrane of the present invention onto the top of the rake drip edge and extended onto the underlayment, which is placed under the drip edge 9. The detail membrane of the present invention will provide for bonding of the roofing material to the dip edge 9, providing for greater wind shear resistance. Install underlayment as required and cut off excess at the rake edge. Install the drip edge up the rake by placing on top of the underlayment 17. Fasten the drip edge as required. Install the detail membrane onto the drip edge extending onto the underlayment. Remove the top release liner and apply shingles 18 as required.

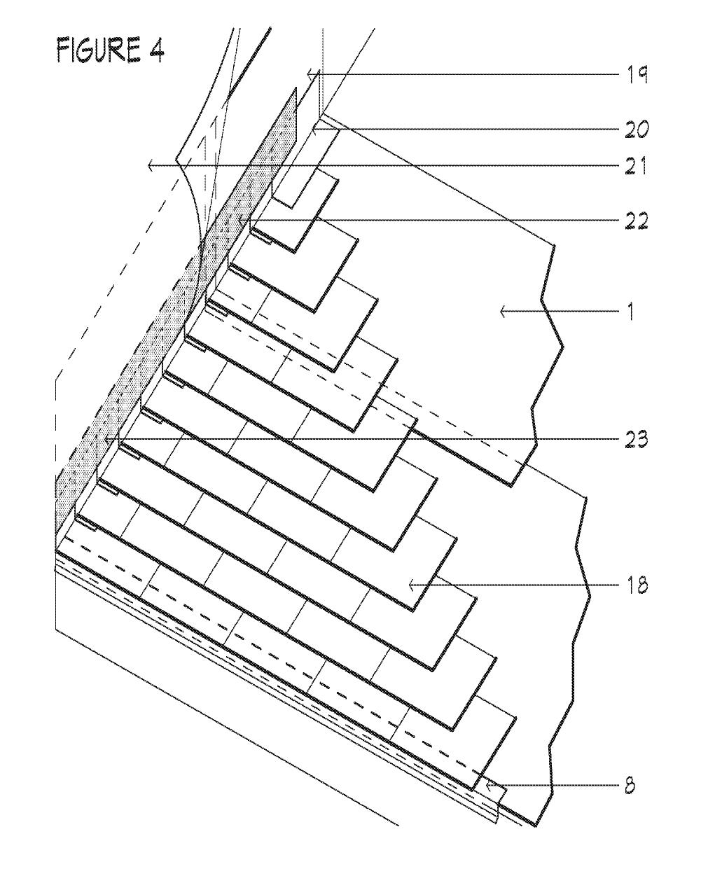

Referring now to FIG. 4, the side wall detail is prone to wicking, particularly if using wood siding components and tracking, when vinyl siding has been installed. In many parts of the country, no self-adhered underlayment is installed up the vertical incline at side wall locations and once the moisture gets behind the step flashing 20 or continuous metal flashing, such as is common in the metal roofing industry, a leak or other damage may occur. At these locations, install the detail membrane 22, 23 of the present invention over the top of the vertical flashing and onto the vertical wall itself. Vertical application techniques and methods for sealing roof systems are disclosed, for example, by U.S. Pat. No. 6,871,472 to Folkersen. At dormer and cheek wall locations, install the detail membrane over top of installed step flashing or head wall flashing and extending onto the wall. This will provide for house wrap 21 adhesion and an additional protective surface, so as to eliminate moisture tracking behind the step flashing or wicking along the siding into the building envelope. Install the detail membrane high enough on the flashing so as to avoid visible signs of its installation once the siding has been completed. Do not remove the top release liner, until the desired house wrap has been installed. At the appropriate time, remove the top side release liner, providing for a strong positive bond between the house wrap and the detail membrane.

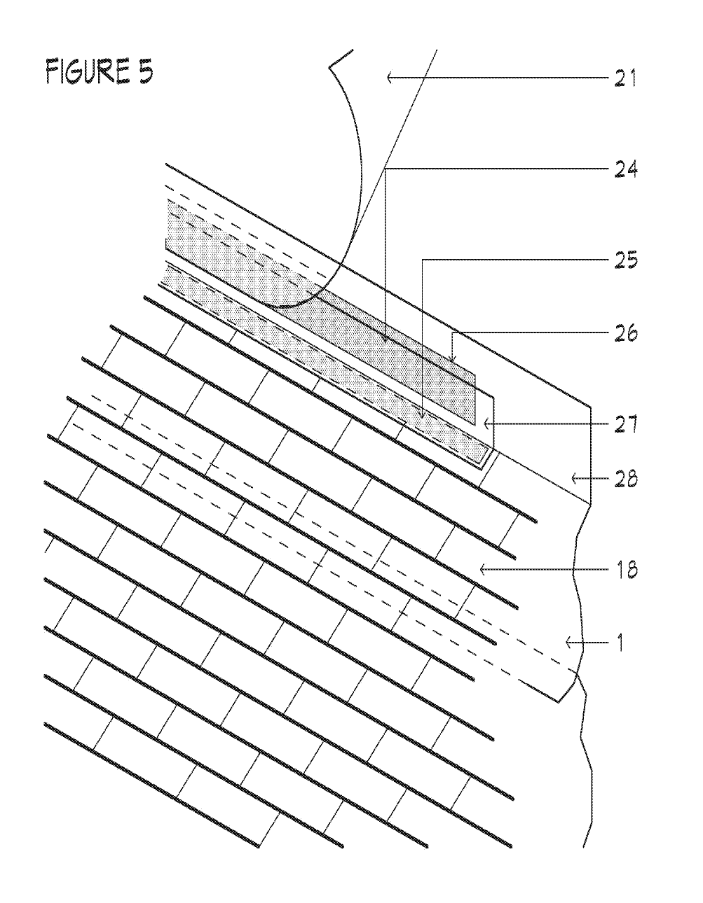

Referring now to FIG. 5, when a shed roof terminates into a vertical wall, the need for head wall flashing becomes a requirement. The detail membrane 24, 25, 26 of the present invention bonds the head wall flashing 27 to the back side of the bottom edge of the house wrap 21, and this detail enhances the performance of siding components abutting the roof area, such as may be required when standing snow or ice begins to melt and is blocked from flowing down the roof plane. The detail membrane of the present invention can also be installed to the underside of the head wall flashing and to the top side of the roof cover material, bonding the metal to the top side of the roofing material. This application relies on the head wall flashing not being over bent, providing for positive pressure towards the roof and the vertical wall. Install the detail membrane of the present invention high enough onto the head wall so as to eliminate its signs, once the siding has been installed. To bond metal head wall flashing to roofing material, install the detail membrane to the underside of the metal head wall flashing, prior to installing the head wall flashing. Do not over-bend the head wall flashing. Nail the top of the head wall flashing through the roof underlayment 28 at the wall. Install the detail membrane onto and over the leading edge of the head wall flashing extending up the vertical incline.

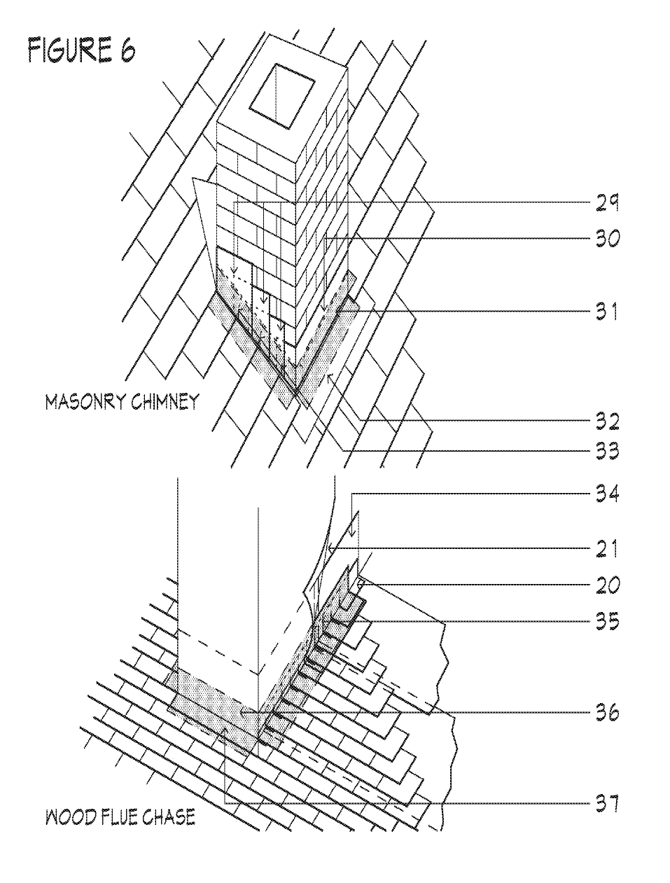

Referring now to FIG. 6, install the detail membrane 31, 35, 36, 37 of the present invention onto the substrate and up the vertical incline, underneath flashing components at chimney locations. The upper panel is a masonry chimney and the bottom panel is a wood flue chase. This will permit for adhesion of the flashing components (step counter flashing 29, base counter flashing 30, step flashing 33, base flashing 32), when installing metal or lead flashing around the perimeter of the chimney. The product can also be installed at metal overlaps, so as to prevent ice back-up and wind-driven rain from entering the building envelope. Install the product starting at the base working towards the cricket area. As each individual piece of lead is flashed into the roof, install another piece of the product lightly tapping the lead forming a non-visible bond. The detail membrane eliminates the use of caulking-type adhesives at the overlaps of the flashing, thereby providing for a neat, clean application. The detail membrane may be used to adhere lead to lead, metal to metal and roofing to metal.

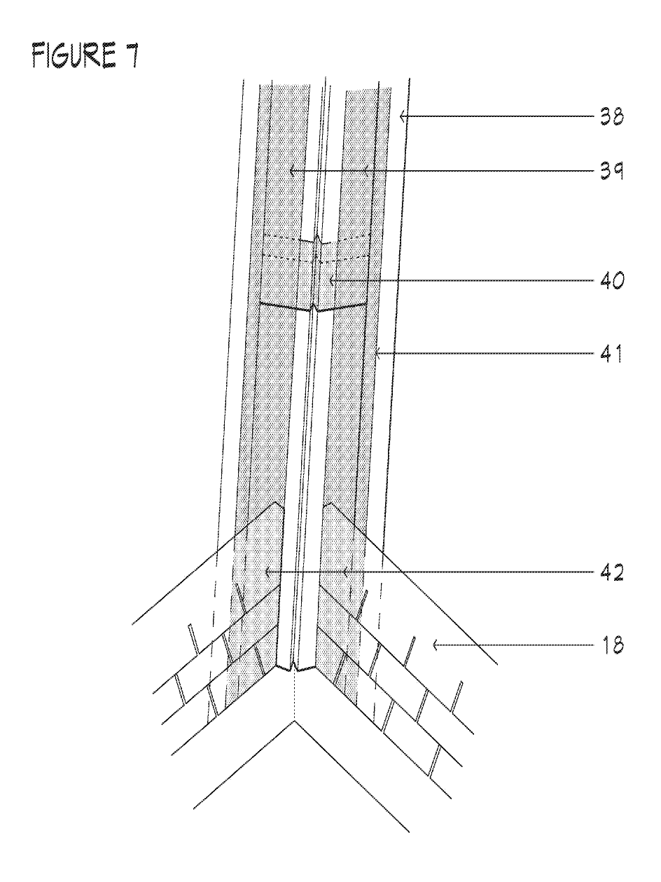

Referring now to FIG. 7, when working with metal valleys 41, the detail membrane 39 of the present invention may be used in place of plastic roof cement, when shingles 18 or other roofing cover materials terminate into the valley area. The industry standard has been to use plastic roof cement, when terminating a cover material 18 into the valley area. The detail membrane 39 of the present invention brings factory controls into the mil requirements for this application. A roof mechanic may be more prone to variations in the amount of a fluid product applied, when using a mastic, such as plastic roof cement. The detail membrane 39 of the present invention can be applied at the metal valley lap joint 40 of the valley pan itself, and as a mechanism of bonding the roofing material to the valley pan 42, thereby preventing water underflow at the interface of the underside of the cover material and the top side of the valley flashing 41. Once the valley profile has been defined, snap a chalk line on which to place the outer edge of the detail membrane 39. The detail membrane 39 can be doubled, if a higher profile is required. Install the detail membrane 39 along the entire length of the valley. Once the shingles have been installed 18, snap a second chalk line extending the shingles 1″ over the detail membrane 39. This will permit for any deviation, when cutting the valley, so as not to expose the detail membrane 39. The detail membrane should be installed at metal valley overlaps 40. Release film installed onto metal during fabrication must be removed 41.

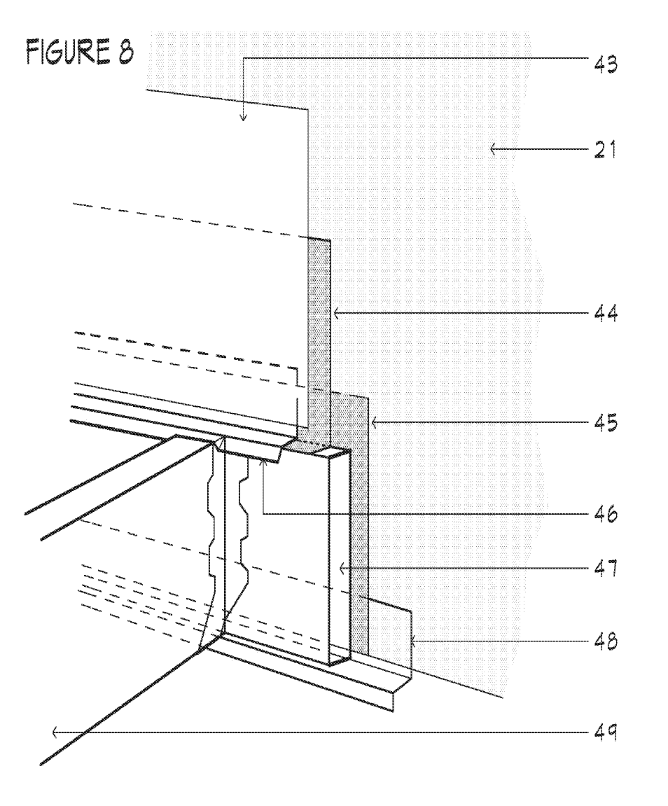

Referring now to FIG. 8, install the detail membrane onto the wall substrate or house wrap 45, prior to installing the deck framing ledger 47. If the deck is elevated with siding underneath, then the use of a “Z” flashing 48 is required, providing for proper watershed. Install the deck ledger 47 onto the detail membrane 45 and fasten as required. Install a second course of the detail membrane 44 onto the deck ledger 47 providing separation of the top side of the deck ledger from the underside of the “Z” flashing. Install the “Z” flashing 46 over the top of the deck ledger 47, prior to installing the decking itself. Install counter-flashing 43 over the exposed detail membrane 44 and over top edge of “Z” flashing 46.

Aluminum has long been the flashing of choice for many builders and is widely available and inexpensive while being relatively easy to work with. In 2004 lumber treated with chromated copper arsenate (CCA) was phased out and replaced with alkaline copper quaternary (ACQ) preservatives, which corrode metals, causing aluminum flashing to became less attractive at deck applications. The detail membrane of the present invention offers one way around this corrosion problem by isolating the aluminum from direct contact with framing lumber. The added benefit is that the aluminum now becomes bonded to the product providing for additional waterproofing characteristics.

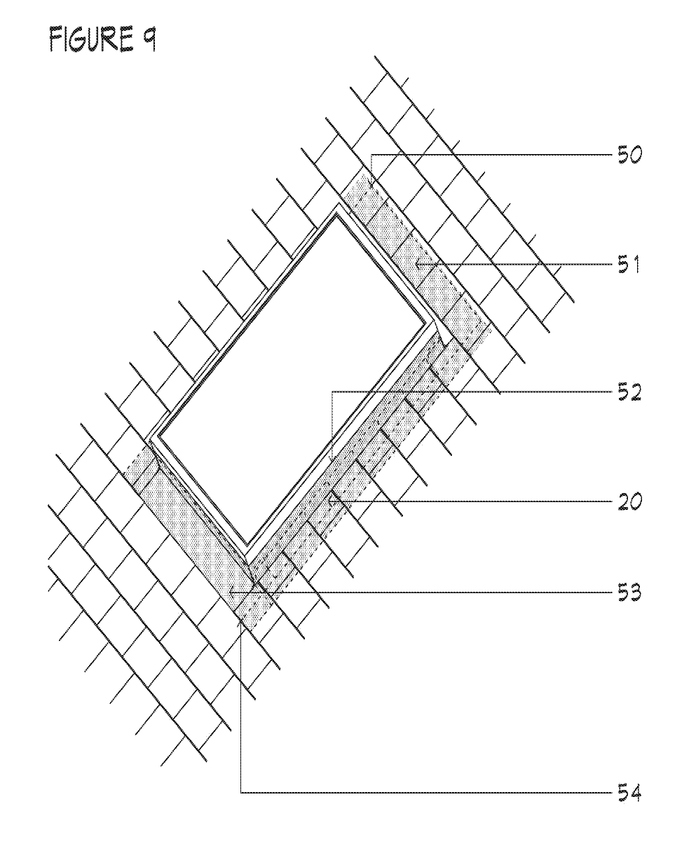

Referring now to FIG. 9, skylights should be installed according to the manufacturers' instructions for that skylight. Skylight window assembly systems and techniques are disclosed, for example, by U.S. Pat. No. 45,913,785. These skylights comprise a curb-mounted frame, providing for vertical application of a self-adhered underlayment. Installing the detail membrane 50, 54 up the curb 52 and onto the substrate provides for synthetic underlayment adhesion, when the underlayment enters the skylight area. Furthermore, the use of plastic roof cement may be eliminated from the head flashing 51, as the detail membrane 50 can provide for starter course adhesion above the skylight itself. Install the detail membrane 50, 54 to the entire frame, prior to installing flashing 20 components. The detail membrane 50, 54 must extend up the vertical incline 52, 53 of the skylight, without interfering with any skylight gaskets of future flashings. Insure a tight 90° termination at this incline 52 and follow by removing the top release film. (1) Wrap the bottom frame 53 with the detail membrane 54. (2) Wrap the side frames 52 with the detail membrane 50 terminating onto the detail membrane 54. (3) Wrap the top frame with the detail membrane 50. On a steep slope roof the top release liner can be left in place if the mechanic has difficulty walking on given area and the bond is not required. Commence to shingle or otherwise roof in the skylight, following the manufacturer recommendations. Once the head flashing 51 has been installed, overlap the substrate leading edge of the head flashing with a second course of the detail membrane to allow for proper drainage. This will sandwich the roof leading edge of the head flashing 51 between two pieces of the detail membrane 50 and permit for starter course adhesion above the skylight, with the goal of preventing moisture infiltration, due to water backing up due to the head flashing 51 itself.

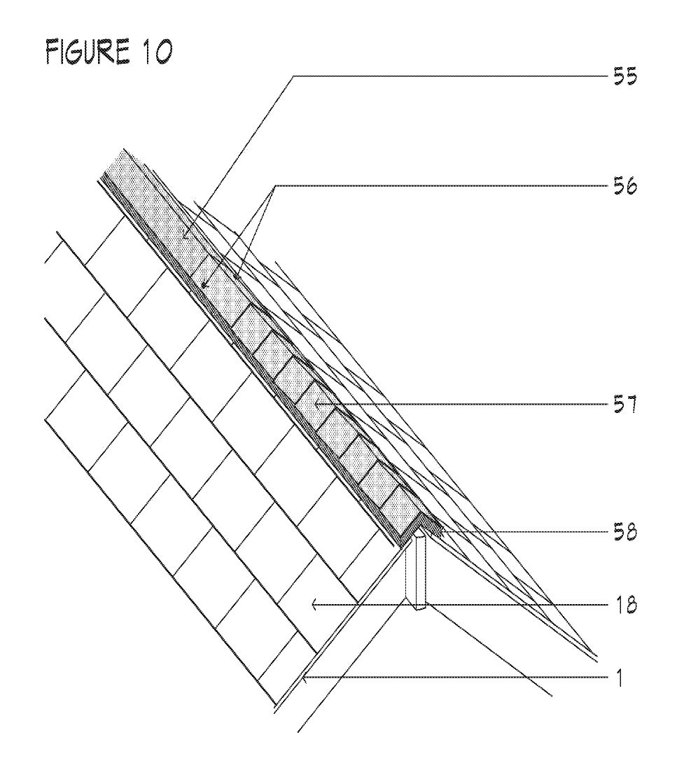

Referring now to FIG. 10, the ridge vent 58 should be installed according to manufacturer's instructions and should be a solid surface material such as Shingle Vent II®, as manufactured by Air Vent, Inc. Many ridge vents 58 come in four foot sections and simply butt at the interface of the next ridge vent 58 being installed, creating a leak-prone area, should the ridge cap 57 become dislodged from the ridge vent 58. The dislodging of ridge cap 57 shingles has become a property and safety issue, which is further mitigated, when using the detail membrane 55 of the present invention to bond the ridge cap 57 material to the top surface of the ridge vent 58. Install ridge vent 58 as recommended by the manufacturer. Working with an assistant, unroll approximately 12″ from the roll of the detail membrane 55 and remove any backer film as required. Attach this portion of the unrolled the detail membrane 55 and proceed by unrolling 3′ to 4′ at time with one person keeping the roll elevated and the other pressing the detail membrane 55 into place, continuing this process until area is completed. When you reach the end of a roll or the application, cut the detail membrane 55 using a utility knife. If the ridge vent 58 is less than 12″ wide, cut off excess. Remove the remaining top side release liner, once cap shingles are ready to be installed, so as to avoid contamination of the adhesive mass due to dust, dirt or moisture. Install the cap shingle 57 using adequate length fasteners, ensuring not to overdrive nails 56 and as recommended by the ridge vent 58 manufacturer. On shingle applications the detail membrane 55 may permit for onetime cap elevation, repositioning and adjustment, prior to final fastening. When using metal, slate or synthetic slate as a ridge cap 57 material a onetime elevation and repositioning may not be possible due the aggressive nature of the bond.

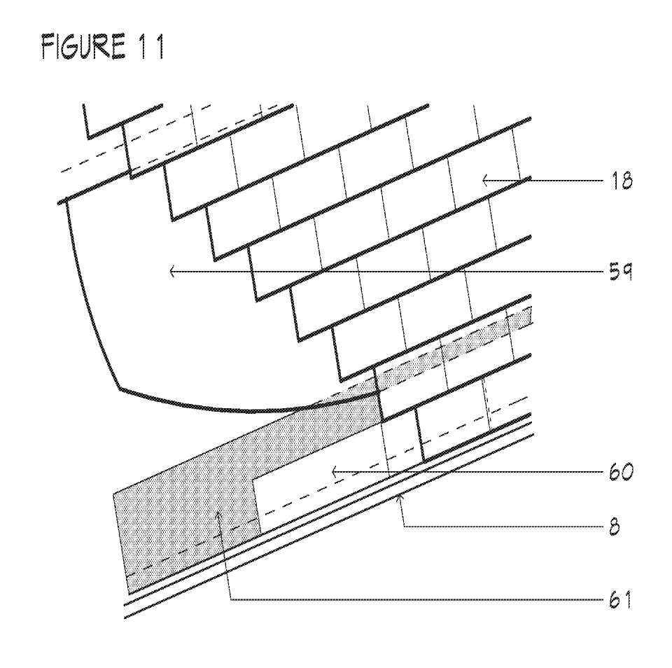

Referring now to FIG. 11, install the detail membrane 61 of the present invention at the eave, prior to installing any underlayment 59 by installing the detail membrane 61 on top of the drip edge 8 and extend up the roof slope onto the substrate, extend the abutting underlayment 59 onto the detail membrane 61 leaving a portion exposed for starter course 60 bonding. The detail membrane 61 of the present invention can be used in conjunction with synthetic underlayments 59 and will further prevent wicking of moisture between the interface of the drip edge 8 and the synthetic underlayment 59. Install the detail membrane 61 on top the drip edge 8 and extend up the roof slope onto the substrate. Extend the abutting underlayment 59 onto the detail membrane 61 5″ leaving 7″ exposed, so as to provide for starter course 60 bonding. Leave the top release liner in place, until the underlayment 59 has been installed. Remove the top release liner, providing for positive adhesion of the underlayment 59. Once the top film has been removed, broom or press the underlayment 59 from ridge to eave, providing for an aggressive bond, without fish-mouthing.

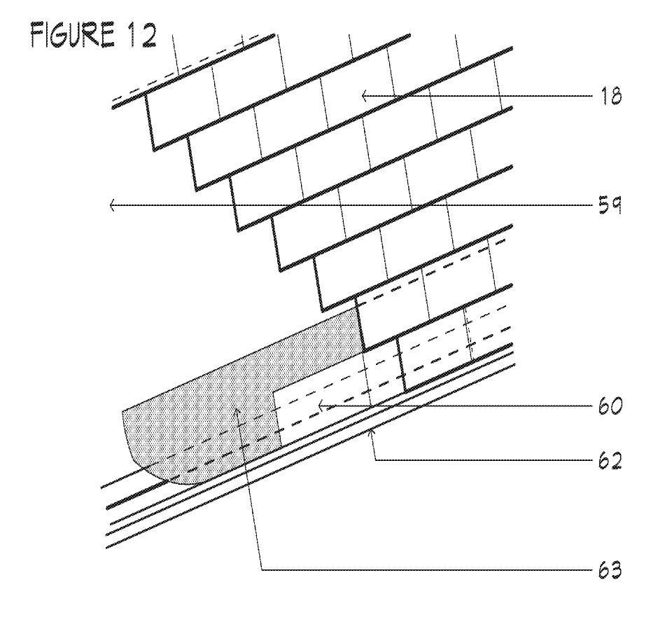

Referring now to FIG. 12, in instances where a self-adhered underlayment 59 has been installed, prior to a drip edge 62, and the self-adhered underlayment 59 cannot be elevated so as to install the drip edge 62 under the self-adhered underlayment, simply install the detail membrane 63 directly from the drip edge 62 onto the underlayment 59 itself. The detail membrane 63 of the present invention is adhered directly to the drip edge 62 and extended onto the underlayment 59. This will provide for the entire with of the detail membrane 63 to be used for starter course 60 adhesion.

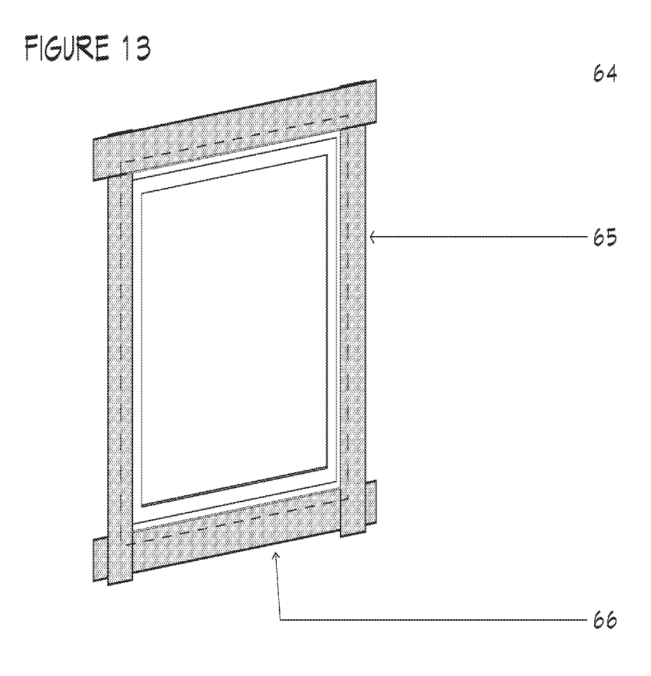

Referring now to FIG. 13, the installation of window tapes and flashings has become commonplace. The industry standard has been to install a product with a cover material, so as to provide for a level of UV stability, while under construction. Examples of these tapes or membranes are of the type commercially available from the by Fortifiber Building Systems Group™ and sold under the trade names of FortiFlash®. FortiFlash® and similar products may be a 25 or 40 mil self-adhesive waterproof membrane, designed for use as a concealed flashing in frame construction, where waterproofing membranes are required. These products are only sticky on one side and will not permit for house wrap adhesion to the top side of the membrane or tape, as is possible with the detail membrane 65 of the present invention. The detail membrane 65 of the present invention can be installed prior to the house wrap and the window can be set, providing for adhesion to the back side of the window flange and the back side of the house wrap 64, if so desired. The detail membrane 65 of the present invention can also be applied over a vinyl window, prior to the installation of siding components. Brick moldings (a wood molding with a specific profile) remain commonplace in the building industry, when trimming out exterior windows and doors. The molding permits for the attachment of the window or door to the rough opening. Generally it has become the industry standard to install a caulking at the interface of the brick molding and the exterior house wrap 64. The use of the detail membrane 65 of the present invention at this interface eliminates the use of caulking materials and provides for a positive bond the abutting siding materials. Install the detail membrane even with the top edge of the window sill 66 and remove the top release liner. Install the window per manufacturer instructions. Apply the detail membrane 65 over vertical fins and remove the release liner. Complete the window application by installing a top horizontal piece of the detail membrane 65 installed over the top fin and extending onto the vertical laps of the detail membrane 65. If an aggressive bond is sought, the house wrap 64 may be adhered to the top horizontal piece of the detail membrane 65. During cold weather applications or when meeting high wind requirements such as may be required in Florida the use of a general purpose mist adhesive is recommended.

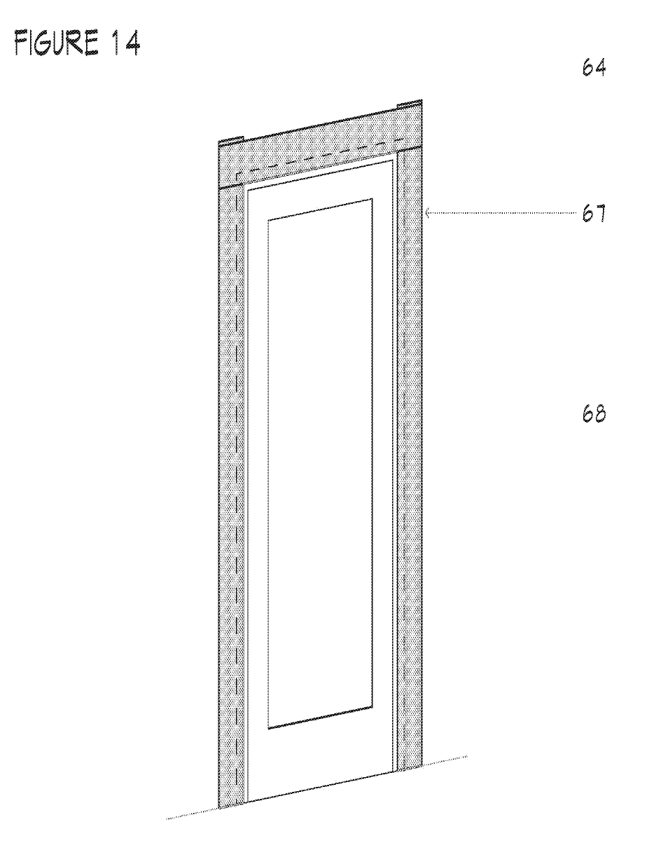

Referring now to FIG. 14, the installation of door tapes and flashings has become commonplace. The industry standard has been to install a product with a cover material, so as to provide for a level of UV stability, while under construction. The products and examples are similar to the applications and methods as found when installing windows. Install the detail membrane 67 even with the leading edge of the rough opening along the sides and horizontal header and remove the top release liner. Install the door per manufacturer instructions. Complete the door application by installing a top horizontal piece of the detail membrane 67 installed over the top fin and extending onto the vertical laps of the detail membrane 67. On vinyl door applications with a nail fin, the detail membrane 67 may be sandwiched between the nail fin so as to eliminate the use of caulking or other adhesives at this interface, while providing for house wrap 64 adhesion.

In all aspects of the embodiment and drawings, it is understood that the use of a release liner is important, so as to prevent the detail membrane of the present invention from sticking to itself or to other unwanted materials, while under construction. When working with products, such as house wraps and synthetic underlayments, the top release will generally remain in place, until the cover material has been top fastened and positioned, as the aggressive bond may not permit for repositioning. Prior art release liner systems and techniques are disclosed, for example, by U.S. Pat. No. 5,916,654 and U.S. Pat. No. 6,426,129. In the past, paper release liners were common in the building industry and have been replaced with polypropylene type films. In addition to providing for a lower cost product, the polypropylene type films considerably reduce the amount of waste generated from a material, which is meant to be discarded.

In certain applications, such as in cool weather, for example, it may be desirable to use an additional adhesive together with the detail membrane of the invention. For example a spray adhesive is a great fit for the invention, when the weather is below 45 degrees F. and may not increase until the following year. Also, the spray adhesive product is an excellent complement to house wraps or synthetic underlayments, particularly when installed in colder temperatures and an immediate aggressive bond is required. However, the spray adhesive product does need to flash off for approximately 10-15 minutes, prior to placing the detail membrane, so as to avoid solvent incompatibility.

The above-described methods of making and using the detail membrane of the present invention provides a cost effective and efficient manner of providing a building structure with storm resistant details. While preferred wraps, assemblies, and methods have been described in detail, various modifications, alterations, and changes may be made without departing from the spirit and scope of the present invention as defined in the appended claims.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1: A method of waterproofing a building envelope and promoting the adhesion of various components thereto comprising:
using a detail membrane comprising:
a reinforced inner core having first and second sides;
a tacky, bitumen-based adhesive bonded to each first and second side of said reinforced inner core, providing tacky upper and lower surfaces; and
an upper and lower release liner removably adhered to said upper and lower surfaces, respectively, wherein said release liners are configured to prevent the tacky upper and lower surfaces from sticking to surfaces during transport and to prevent the adhesion of debris thereto prior to use;
wherein rubber polymers and/or styrene-rubber block copolymers and/or other elastic materials are added to said bitumen-based adhesive;
bonding an underside of an exposed cover roofing material to an underlying roofing material on a building envelope;
wherein said underlying roofing material may be a substrate, underlayment, drip edge, flashing or similar.

2: The method of claim 1 wherein said reinforced core of said detail membrane comprises a non-woven mat of glass fibers interposed between and mutually bonded to each first and second side.

3: The method of claim 2 wherein bonding an underside of an exposed cover roofing material to an underlying roofing material on a building envelope comprises:
removing said lower release liner just prior to installation on a building envelope;
pressing the detail membrane onto a surface of a building envelope;
removing said upper release liner just prior to installation thereof; and
pressing a cover material into the exposed, tacky upper surface of said detail membrane.

4: The method of claim 3 wherein said detail membrane is provided in a roll form.

5: The method of claim 4 wherein said detail membrane is applied to said surface of said building envelope by unrolling of approximately 12″ thereof, removing said lower release liner just prior to installation, pressing said unrolled portion onto said surface of said building envelope, and subsequently unrolling 3′-4′ and pressing said unrolled portion onto said surface of said building envelope until the area has been covered.

6: The method of claim 1 wherein said detail membrane is applied onto said surface of said building envelope using 4″ side laps.

7: The method of claim 1 wherein any uphill courses of detail membrane applied to said surface of building envelope are lapped downhill to ensure watershed.

8: The method of claim 1 wherein, where the detail membrane is applied to said surface of said building envelope using a roller.

9: The method of claim 1 wherein, if the area to be sealed is a rake or other location utilizing a drip edge, the method further comprises installing an underlayment to the underlying roofing material on the building envelope and fastening a drip edge to said underlayment prior to bonding an underside of the exposed cover roofing material to the underlying roofing material, in this case the drip edge and underlayment, on the building envelope.

10: The method of claim 1 wherein, if said detail membrane is bonded to flashing installed at wall sheathing, head laps, side laps, corners or gable end terminations when installing house wraps as an underlying roofing material, said detail membrane is bonded to said underlying roofing material on said building envelope at a height sufficient to avoid visible signs of its installation, once an exposed cover roofing material has been installed.

11: The method of claim 1 wherein, if the detail membrane is to be installed at dormer and cheek wall locations, it is installed over the top of any installed step flashing or head wall flashing and in such a manner that it extends onto said wall.

12: The method of claim 1 wherein, in areas using head wall flashing, said detail membrane is bonded to said head wall flashing prior to being bonded to the underlying roofing material on the building envelope.

13: The method of claim 12 wherein, where said detail membrane is installed at a head wall, said detail membrane is installed over a leading edge of any head wall flashing and is extended up a vertical surface of said head wall prior to bonding of said exposed cover roofing material.

14: The method of claim 1 wherein, if the detail membrane is to be installed in a valley area, the method further comprises, after defining the valley area, snapping a chalk line spanning the length of the valley on which to place an outer edge of the detail membrane, installing the detail membrane along the chalk line, after installing said detail membrane, snapping a second chalk line approximately 1″ outward from an outer edge of said detail membrane, and installing an exposed cover roofing material on top of the detail membrane, aligned with said second chalk line, thereby covering the detail membrane and permitting for any deviation when cutting the valley that may otherwise expose said detail membrane.

15: The method of claim 1 wherein, if the detail membrane is to be installed at an eave the method further comprises prior to installing any underlayment, installing the detail membrane on top of a drip edge in contact with the building envelope, extending up a slope of said roof onto a substrate, extending any abutting underlayment onto said detail membrane without completely covering an upper surface thereof, so as to leave surface for later starter course shingle adhesion, removing said upper release liner, and pressing said underlayment and starter course shingles into said detail membrane, thereby securing them thereto.

16: A method of waterproofing a building envelope and promoting the adhesion of various components thereto comprising:
using a detail membrane comprising:
a reinforced inner core having first and second sides;
a tacky, bitumen-based adhesive bonded to each first and second side of said reinforced inner core; and
rubber polymers and/or styrene-rubber block copolymers and/or other elastic materials added to said bitumen-based adhesive;
to bonding two like roofing materials together on a building envelope.

17: The method of claim 16 wherein said reinforced core of said detail membrane comprises a non-woven mat of glass fibers interposed between and mutually bonded to each first and second side.

18. The method of claim 2 wherein bonding two like roofing materials together on a building envelope comprises:
removing said lower release liner just prior to installation on a first roofing material;
pressing the detail membrane onto said first roofing material;
removing said upper release liner just prior to installation thereof on a second like roofing material; and
pressing said second like roofing material into the exposed, tacky upper surface of said detail membrane.

19: A method of waterproofing a building envelope and promoting the adhesion of various components thereto comprising:
using a detail membrane comprising:
a reinforced inner core having first and second sides;
a tacky, bitumen-based adhesive bonded to each first and second side of said reinforced inner core;
rubber polymers and/or styrene-rubber block copolymers and/or other elastic materials added to said bitumen-based adhesive;
adhering the detail membrane between any surfaces previously requiring sealing using caulking, plastic roof cement, mastic or any other traditional material used on a sloped roof or the walls of a building exterior.

20: The method of claim 19 wherein said reinforced core of said detail membrane comprises a non-woven mat of glass fibers interposed between and mutually bonded to each first and second side.
